(19) United States
(12) Patent Application Publication
(10) Pub. No.: US 2009/0261054 A1
(43) Pub. Date: Oct. 22, 2009

(54) Infant Feeding Pouch

(76) Inventor: Qwentella Shawnell Shelby, Rock Hill, SC (US)

Correspondence Address: WHITE-WELKER & WELKER, LLC, P.O. BOX 199, CLEAR SPRING, MD, 21722-0199, US

(21) Appl. No.: 12/107,284

(22) Filed: Apr. 22, 2008

(51) Int. Cl. A61J 9/00; A61J 9/08; A45F 3/16

(52) U.S. Cl. 215/11.3; 215/11.6; 224/148.1; 215/11.1

(57) ABSTRACT

The present invention is an infant feeding pouch that is a transparent low-density polyethylene or polypropylene bag. The pouch has two sections, a middle section and two side wings. The middle section of the pouch is collapsible. The wings are sealed close and do not contain any fluid. The entire device is disposable. The middle oval section is able to contain 8 to 9 ounces of fluid. As the fluid enters the middle section it enlarges. As the fluid exits the pouch it collapses. The middle section of the feeder has an opening; it is here were the fluid is deposited. The opening is located in the center of the middle section at the bottom. The middle section has a non-removable threaded fitting welded onto the pouch enabling the toppro to be attached. The toppro is a bottle cap with screwable threads in the interior.

### CROSS REFERENCE TO RELATED APPLICATIONS

This application is related to U.S. Provisional Patent Application Ser. No. 60/874,259, entitled “Paternal Infant Feeding Pouch”, filed on Dec. 12, 2006.

### FEDERALLY SPONSORED RESEARCH

Not Applicable

### SEQUENCE LISTING OR PROGRAM

Not Applicable

### TECHNICAL FIELD OF THE INVENTION

The present invention relates generally to an infant feeding device. More specifically, the present invention relates to an infant feeding pouch that provides bonding means through artificial breastfeeding.

### BACKGROUND OF THE INVENTION

The responsibilities regarding breastfeeding lie exclusively on the maternal parent. These issues have not been addressed in today's society and the prior art. The problems with existing products and those taught in the prior art include the anatomy of the devices taught, the lack of paternal influence, the inability to dispose, and the inaccessibility linked with traveling.

Some have offered devices in an attempt to overcome the aforementioned shortcomings, but all have failed for various reasons discussed below. For example, U.S. Pat. No. 4,776,546 teaches a bib-like device for assisting in nursing a child and improving bonding between a parent and the child. The device includes a bib-like member made from a fabric, such as terry cloth, comfortable for the child. The device defined includes a generally mammary-shaped area defining a pouch therein for retaining a container of liquid, such as formula, milk, juice, or water for the child. The pouch is sized to receive the container therein and communicates with an opening in the fabric for permitting a nipple on the container to protrude therefrom. When worn by either parent, the device improves bonding between the child and parent, especially for the male, by anatomically simulating the female.

U.S. Pat. No. 5,582,335 teaches a nursing baby bottle holder for supporting a baby bottle in a nursing position is provided. The baby bottle has a body portion and a neck portion. The holder comprises a length of material defining an annular open end to releasably secure the body portion of the baby bottle. The length is sufficient to drape the material around a neck of a user while supporting the baby bottle in a nursing position.

U.S. Pat. No. 6,669,064 teaches a bonding nurser that can be used to closely approximate breast feeding mechanically and psychologically comprises a feeding container that simulates a breast in fluid delivery, shape, texture, feel, and ease of infant suckling releasably attached to a sling so that the container is positioned on the breast area of the adult feeding the baby, and the adult's hands are free for cuddling the baby during feeding. The feeding container is a breast-shaped flexible housing that holds a collapsible bag which delivers milk or other fluids through a nipple protruding through the apex of the housing and is filled through a screw cap opening at the base opposite the apex and secured in the housing by retaining straps surfaced with Velcro. When the container is assembled, i.e., a bag is positioned in the housing, the straps present a loop interface that mechanically couples the base of the container to a correspondingly sized hook-surfaced area on a shoulder strap (or a hand strap).

What is needed is an infant feeding pouch that includes proper anatomy, is easily disposed, sterile, and safe. Conventional devices known in the prior art as discussed above consist primarily of a pouch and nipple, or means for holding a standard bottle. The pouch devices do not have the feeling of a female breast and the pouch, if part of the device, cannot be used more than once.

Additionally, a pouch has to be mounted on shirt, and the contents in pouch may not be emptied in one feeding and no means for storing milk is provided.

Therefore, it is an objective of the present invention to teach an infant feeding pouch that overcomes these disadvantages.

### SUMMARY OF THE INVENTION

The present invention is an infant feeding pouch that is a transparent low-density polyethylene or polypropylene bag. The pouch has two sections, a middle section and two side wings. The middle section of the pouch is collapsible. The wings are sealed close and do not contain any fluid. The entire device is disposable. The middle oval section is able to contain 8 to 9 ounces of fluid. As the fluid enters the middle section it enlarges. As the fluid exits the pouch it collapses.

The middle section of the feeder has an opening, it is here were the fluid is deposited. The opening is located in the center of the middle section at the bottom. The middle section has a non-removable threaded fitting welded onto the pouch enabling the toppro to be attached. The toppro is a bottle cap with screwable threads in the interior.

The primary advantage of the present invention is to teach a disposable infant feeding pouch that can store milk and be used for one feeding. The pouch of the present invention provides a nipple that protrudes making it easier for the infant to latch on the feeding pouch. The infant feeding pouch of the present invention can also be filled with ready-to-feed milk and milk warmed by body heat.

Another advantage of the present invention is that it is required to be mounted or connected to a shirt for use.

Yet another advantage of the present invention is that the infant feeding pouch is hands-free, strapless, disposable, and collapsible that enables an infant to mimic breastfeeding with parent.

Another advantage of the present invention is that the pouch collapses and pushes the fluid from the nipple eliminating air in the pouch and infant's stomach. Additionally, the pouch is BPA free and pre-sterilized for safety.

Still another advantage is that the pouch adheres to a t-shirt or blouse and can be pulled off easily to dispose. While in use, a parent can hold a baby in different positions so both are comfortable and the baby can eat sitting up if desired.

### BRIEF DESCRIPTION OF THE DRAWINGS

The accompanying drawings, which are incorporated herein and form a part of the specification, illustrate the present invention and, together with the description, further serve to explain the principles of the invention and to enable a person skilled in the pertinent art to make and use the invention.

FIG. 1 is an exploded view of the infant feeding pouch of the present invention;

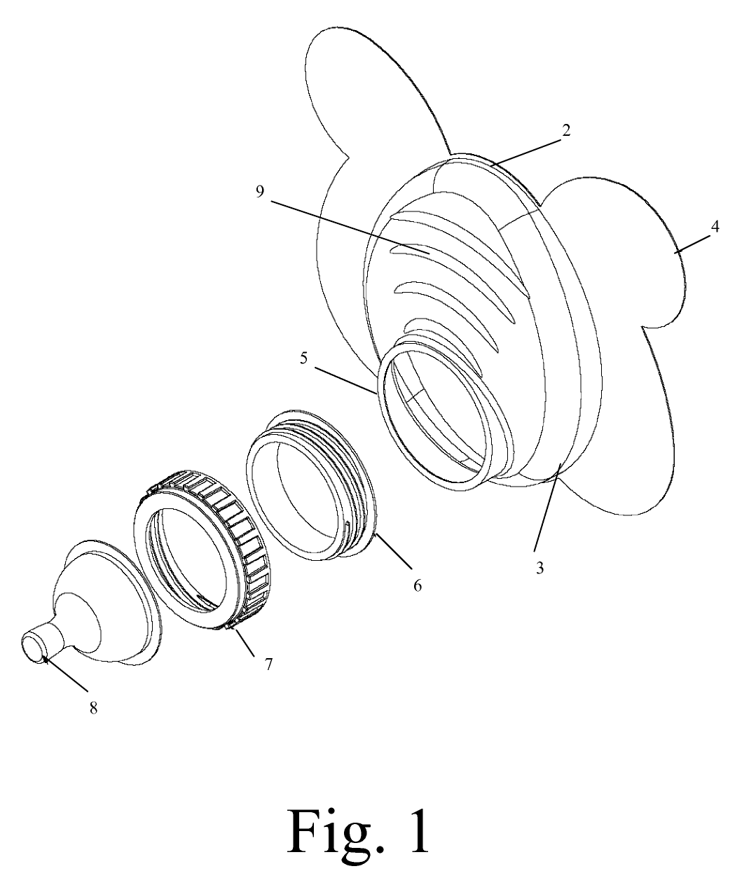

FIG. 2 illustrates a perspective view of the infant feeding pouch of the present invention;

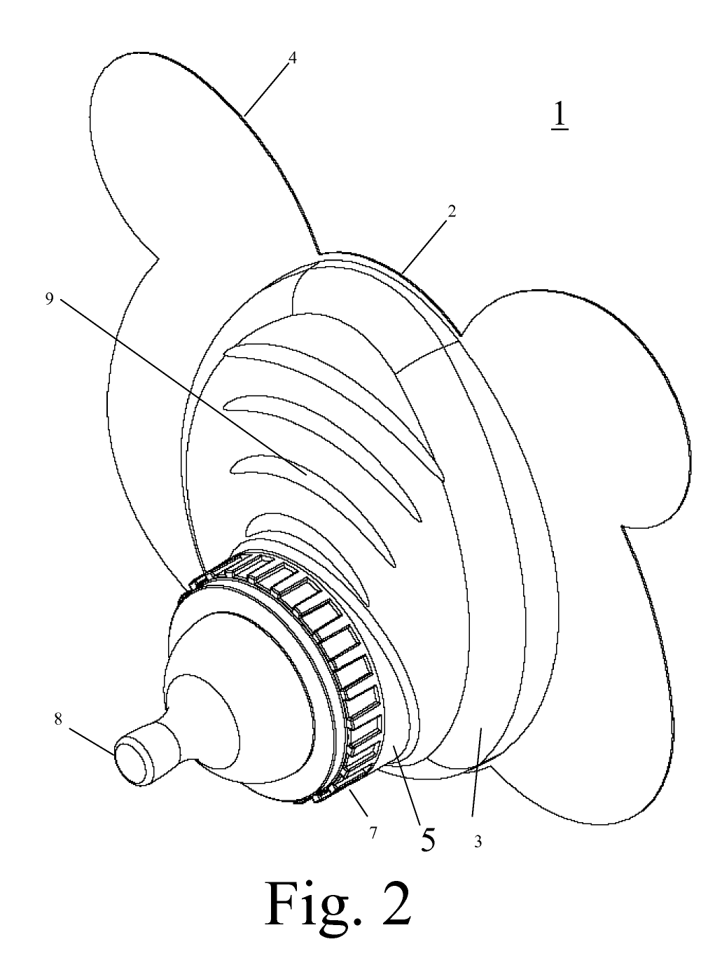

FIG. 3 is a side plan view of the infant feeding pouch of the present invention; and

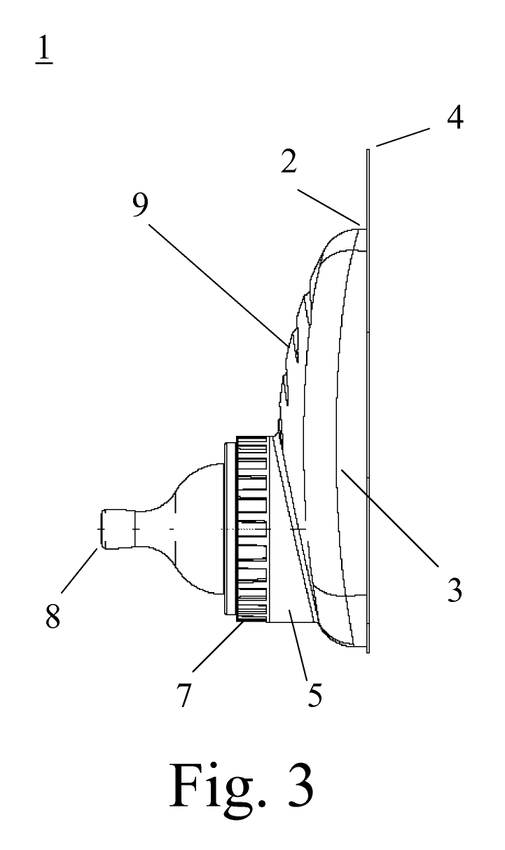

FIG. 4 is a cut away view of the infant feeding pouch of the present invention.

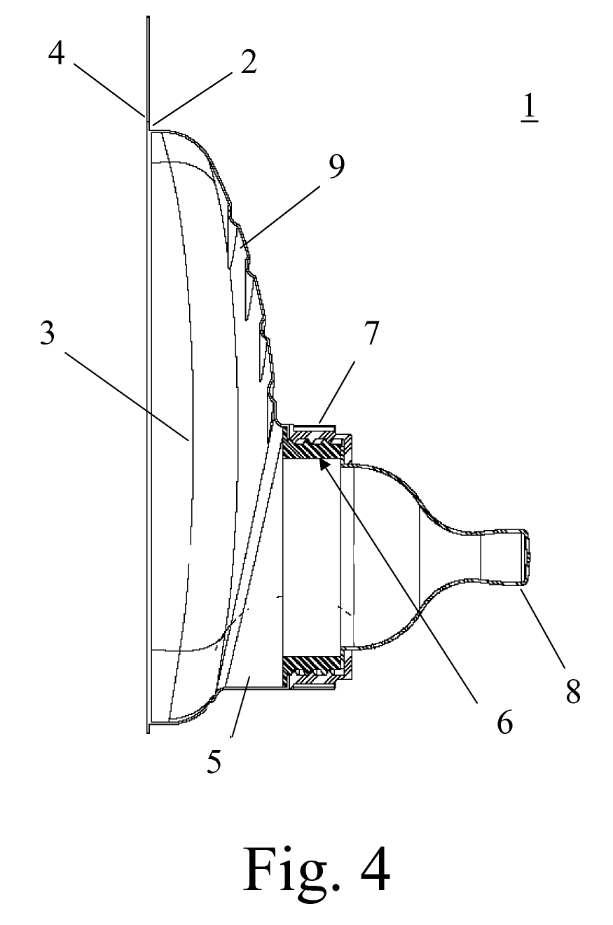

### DETAILED DESCRIPTION OF THE INVENTION

In the following detailed description of the invention of exemplary embodiments of the invention, reference is made to the accompanying drawings (where like numbers represent like elements), which form a part hereof, and in which is shown by way of illustration specific exemplary embodiments in which the invention may be practiced. These embodiments are described in sufficient detail to enable those skilled in the art to practice the invention, but other embodiments may be utilized and logical, mechanical, electrical, and other changes may be made without departing from the scope of the present invention. The following detailed description is, therefore, not to be taken in a limiting sense, and the scope of the present invention is defined only by the appended claims.

In the following description, numerous specific details are set forth to provide a thorough understanding of the invention. However, it is understood that the invention may be practiced without these specific details. In other instances, well-known structures and techniques known to one of ordinary skill in the art have not been shown in detail in order not to obscure the invention.

Referring to the figures, it is possible to see the various major elements constituting the apparatus of the present invention. The present invention is an infant feeding pouch.

The infant feeding pouch of the present invention is used to assist with breastfeeding an infant. An infant that is breastfed can use the feeding pouch when the mother is not available. The pouch also allows adoptive mothers, spouses, and grandparents to help with the breastfeeding responsibilities. The feeding pouch is not shaped like a breast so it will not alienate the spouse. The pouch is BPA-free contains and no polycarbonate material. The pouch also allows mothers who have undergone a caesarian to position the infant easier. The pouch provides bonding between both parents. Most bottles allow for the paternal parent to feed baby but do not provide for a bonding experience equal to that reported by breastfeeding parents. It is also accessible when traveling to open places to feed like malls, restaurants, and family outings.

Now referring to the Figures, the infant feeding pouch 1 is comprised of a transparent low-density polyethylene or polypropylene pouch 2. The low-density polyethylene pouch 2 has two sections, a middle section 3 and two side wings 4. The middle section 3 of the pouch 2 is collapsible. The two side wings 4 are sealed close. The entire infant feeding pouch 1 is disposable. The middle section 3 is oval in shape and is able to contain 8 to 9 ounces of fluid. As the fluid enters the middle section 3 it enlarges by expanding the low density polyethylene or poly propylene material against its inherent elasticity and the expansion portions 9 located on the anterior surface of the middle section 3. As the fluid exits the middle section 3 it collapses the expansion portions 9 located on the anterior surface of the middle section 3 returns to their resting state due to the elasticity of the low-density polyethylene or polypropylene material from which the pouch 2 is made.

The middle section 3 of the infant feeding pouch 1 has an opening support 5 providing means for connecting a fitting 6 to the pouch 1 via the opening support 5 which on its anterior surface that is typically circular in shape and it is here where the fluid is deposited into the middle section 3. The opening support 5 is located in on the bottom center of the anterior surface of the middle section 3 and provides attachment means for the nipple in a manner where the nipple opening is perpendicular to the anterior surface of the middle section 3. The middle section 3 has a non-removable fitting 6 welded onto the opening support 5 located on the middle section 3. The fitting 6 has threads on its exterior. The fitting has screwable threads enabling a toppro 7 to be attached. The toppro 7 is made like a bottle cap with screwable threads in its interior and provides securing means to retain a nipple 8.

The detachable nipple 8 is located inside a plastic cap, referred to as a toppro 7, when not in use. The detachable nipple 8 is made form silicon and is reusable. The toppro 7 is made of plastic and has an opening to attach the silicon nipple. The detachable nipple 8 has the anatomy of a protruding human nipple. The detachable nipple 8 may have a hook shape at the tip of the nipple. The toppro 7 has screwable grooves located in its interior. The detachable nipple 8 has a hole located at the tip of the nipple to extract fluid. The detachable nipple 8 and toppro 7 are located in the front of the infant feeding pouch.

The two side wings 4 cannot contain any fluid as they are sealed off from the middle section 3. The pouch takes the shape of a bumblebee or half moon. The posterior side of the middle section 3 may be provided with adhesive, hook and loop fastener, or other attachment means known in the prior art that allow one to stick the infant feeding pouch 1 on a t-shirt or blouse. When used, adhesive covers ⅔ of the posterior side of the middle section 3 of the feeding pouch. The infant feeding pouch 1 can also be made without the wings.

The method for manufacturing the infant feeding pouch starts with extruding blown films sheets. Next, two sheets are cut to a desired shape and heat-sealed. The two sheets are made of LLDPE back film and heat-sealed. The wings are made of PP, which can be punched with steel rule die blanking from a sheet. The front film is retrofitted with the toppro and nipple assembly. The nipple is made of heat-resistant silicon.

In an alternative manufacturing method 2-¼″ 12-undoubled start thread is used with BOPP films (food grade). The film is cut using die cutting technology and the edges are sealed with heat and 0.25″ seaming. In this manufacturing process, the wings would be injection molded and welded on.

In yet another alternative manufacturing method, the pouch is blow molded with the wings injection molded and later heat-sealed.

In all manufacturing processes, the threads are spiral and inclined, while the fitting and toppro parts are injection molded with the fitting heat sealed on the pouch.

Thus, it is appreciated that the optimum dimensional relationships for the parts of the invention, to include variation in size, materials, shape, form, function, and manner of operation, assembly and use, are deemed readily apparent and obvious to one of ordinary skill in the art, and all equivalent relationships to those illustrated in the drawings and described in the above description are intended to be encompassed by the present invention.

Furthermore, other areas of art may benefit from this method and adjustments to the design are anticipated. Thus, the scope of the invention should be determined by the appended claims and their legal equivalents, rather than by the examples given.

The embodiments of the invention in which an exclusive property or privilege is claimed are defined as follows:

1. An feeding pouch, comprising:
a pouch consisting of a middle section providing means for retaining a fluid;
said middle section is comprised of an opening support on a first anterior surface that provides means for a fluid to be deposited into the middle section;
a non-removable fitting secured to the opening support located on the middle section;
said fitting comprised of an exterior threaded surface providing attachment means;
a toppro comprised of a threaded interior surface providing attachment and securing means to the threaded exterior surface of said fitting;
a nipple; and
said toppro further comprised of securing means for securing said nipple.

2. The feeding pouch of claim 1 wherein the pouch is made from transparent low-density polyethylene or polypropylene.

3. The feeding pouch of claim 1 wherein pouch has two sections, a middle section and one or more side wings.

4. The feeding pouch of claim 3 wherein the side wings are sealed closed and separate from the middle section and are unable to retain any fluids.

5. The feeding pouch of claim 1 wherein the middle section is oval in shape and is able to contain 8 to 9 ounces of fluid.

6. The feeding pouch of claim 1 wherein the opening support on the first anterior surface of the middle section is circular in shape.

7. The feeding pouch of claim 6 wherein the opening support is located on the bottom center of the anterior surface of the middle section.

8. The feeding pouch of claim 3 wherein the pouch takes the shape of a bumblebee.

9. The feeding pouch of claim 1 wherein the posterior side of the middle section is provided with attachment means enabling attachment to an article of clothing.

10. The feeding pouch of claim 9 wherein when adhesive is used as the attachment means, said adhesive covers ⅔ of the posterior side of the middle section of the pouch.

11. The feeding pouch of claim 2 wherein as the fluid enters the middle section it enlarges by expanding against the inherent elasticity of the material from which the middle section is made; and
as the fluid exits, the middle section returns to its resting state due to the inherent elasticity of the material from which the middle section is made.

12. The feeding pouch of claim 1 wherein the anterior surface of the middle section is further comprised of expansion means so that
as the fluid enters the middle section it expands the expansion portions located on the anterior surface of the middle section to accommodate the fluid; and
as the fluid exits the middle section it collapses the expansion portions located on the anterior surface of the middle section and returns them to their resting position.

13. The feeding pouch of claim 3 wherein the pouch takes the shape of a half moon.
